(19) United States
(12) Patent Application Publication
(10) Pub. No.: US 2025/0180063 A1
(43) Pub. Date: Jun. 5, 2025

(54) U-BOLT SPACER AND METHOD OF USE

(71) Applicant: WHITE MULE COMPANY, Ontario, OH (US)

(72) Inventors: Larry Steven Ritchey, Mansfield, OH (US); Andrew Patrick Ritchey, Mansfield, OH (US)

(21) Appl. No.: 18/969,794

(22) Filed: Dec. 5, 2024

Related U.S. Application Data
(60) Provisional application No. 63/606,112, filed on Dec. 5, 2023.

(51) Int. Cl. F16B 43/00; F16B 35/04

(52) U.S. Cl. CPC F16B 43/00; F16B 35/048

(57) ABSTRACT

A U-bolt spacer for use with a U-bolt is provided. The U-bolt spacer can include a body and a channel. The body can include a first end and a second end. The channel can be formed in the body and can extend along the body from the first end to the second end. Each of the first end and the second end can have a complementary curvature designed to cooperate with one or more curved transitions of the U-bolt. The U-bolt spacer can help maintain the position of the U-bolt after installation, ensuring that it remains securely in place and minimizes any movement that could lead to loosening or misalignment during use. The U-bolt spacer can assist in distributing pressure more evenly, militating against stress concentrations that can otherwise lead to localized damage.

### CROSS-REFERENCE TO RELATED APPLICATIONS

This application claims the benefit of U.S. Provisional Application No. 63/606, 112, filed on Dec. 5, 2023. The entire disclosure of the above application is incorporated herein by reference.

### FIELD

The present technology relates generally to devices for the transportation of vehicles and, more particularly, to a U-bolt spacer for use with a saddle-mount for coupling multiple vehicles together for transport.

### INTRODUCTION

This section provides background information related to the present disclosure which is not necessarily prior art.

Various devices may be used to couple vehicles for towing a disabled vehicle or transporting vehicles between locations. In truck applications, a saddle-mount may be used to connect a lead vehicle to a towed vehicle or a series of vehicles. The saddle-mount is attached to either the lead truck's fifth wheel or its frame. It is then coupled to the front axle of the towed vehicle, lifting its front end off the ground and allowing the rear wheels to roll. Additionally, multiple saddle-mounts can be combined to tow additional vehicles in series, enabling the transport of up to four trucks with the use of three saddle-mounts. An example of a saddle-mount with a clamp assembly is described in U.S. Patent Application Publication No. 2022/0194150A1, titled TRUCK SADDLE-MOUNTS WITH J-CLAMP, which is incorporated herein by reference.

The saddle-mount is securely attached to the lead vehicle during operation. U-bolts including threaded fasteners may be used to secure the saddle-mount to the frame of the lead truck. However, it has been observed that improperly sized U-bolts may result in undesired threading extending above the fasteners. This issue may be addressed through use of a single split lock washer in combination with multiple flat washers to elevate a nut installed on the U-bolt, allowing the nut to be reached with a socket. In certain cases, wooden blocks may be used to adjust spacing of the U-bolt during installation, or no spacer at all is employed, making coupling/decoupling the nut on threaded U-bolt difficult. These approaches, however, compromise the performance of the split lock washer, which becomes effective only in locking the fastener to the first flat washer. As a result, the lock washer may be unable to prevent relative movement between the threaded components of the U-bolt, reducing its ability to maintain a secure attachment during operation. Furthermore, when one or more wooden blocks are used as spacers, such blocks may compress or crack under load, leading to loosening of the U-bolt and interfering with a secure coupling of the saddle-mount. In cases where no spacer is used, stress points can develop, impinging on and potentially damaging the frame of the truck. These issues highlight the need for an improved coupling system for saddle-mounts.

Accordingly, there is a continuing need for a coupling system for a saddle-mount that can distribute the load forces of the U-bolts over a large area on the frame, ensure proper U-bolt fitment for a secure attachment to the lead vehicle during operation, and reduce the need for maintaining a large inventory of U-bolt sizes.

### SUMMARY

In concordance with the instant disclosure, a U-bolt spacer having a complementary fitment with a U-bolt that can distribute load forces over a large area on the frame and ensure proper U-bolt fitment for a secure attachment to a lead vehicle during operation, has surprisingly been discovered. The present technology includes articles of manufacture, systems, and processes that relate to a U-bolt spacer having a complementary fitment with a U-bolt that can distribute the load forces over a large area on the frame and facilitate proper sizing of U-bolts.

In certain embodiments, a U-bolt spacer can include a body and a channel. The body can include a first end and a second end. The channel can be formed in the body and can extend along the body from the first end to the second end. The first end and the second end can each have a complementary curvature designed to cooperate with one or more curved transitions of the U-bolt.

In certain embodiments, a method of using a U-bolt spacer with a U-bolt can include providing the U-bolt and the U-bolt spacer. The U-bolt spacer can include a body and a channel. The body can include a first end and a second end. The channel can be formed in the body and can extend along the body from the first end to the second end. The first end and the second end can each have a complementary curvature designed to cooperate with one or more curved transitions of the U-bolt. Then the channel of the U-bolt spacer can be disposed adjacent the connecting portion of the U-bolt between the substantially parallel arms.

In certain embodiments, a system for coupling a saddle-mount to the frame of a truck with a U-bolt spacer and a U-bolt can include the U-bolt spacer, the U-bolt, and one or more nuts. The U-bolt spacer can include a body and a channel. The body can include a first end and a second end. The channel can be formed in the body and can extend along the body from the first end to the second end. The first end and the second end can each have a complementary curvature designed to cooperate with one or more curved transitions of the U-bolt.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a U-bolt spacer, according to an embodiment of the present disclosure;

FIG. 2 is top perspective view of a U-bolt;

FIG. 3 is a bottom perspective view of the U-bolt spacer, according to the embodiment shown in FIG. 1;

FIG. 4 is a top plan view of the U-bolt spacer, according to the embodiment shown in FIG. 1;

FIG. 5 is a front elevational view of the U-bolt spacer, according to the embodiment shown in FIG. 1;

FIG. 6 is a side elevational view of the U-bolt spacer, according to the embodiment shown in FIG. 1;

FIG. 7 is a cross-sectional view of the U-bolt spacer taken at section line A-A in FIG. 6, according to the embodiment shown in FIG. 1;

FIG. 8 is a top perspective view of a U-bolt spacer, according to another embodiment of the present disclosure;

FIG. 9 is a bottom perspective view of the U-bolt spacer, according to the embodiment shown in FIG. 8;

FIG. 10 is a top plan view of the U-bolt spacer, according to the embodiment shown in FIG. 8;

FIG. 11 is a front elevational view of the U-bolt spacer, according to the embodiment shown in FIG. 8;

FIG. 12 is a side elevational view of the U-bolt spacer, according to the embodiment shown in FIG. 8;

FIG. 13 is a top perspective view of a U-bolt spacer, according to yet another embodiment of the present disclosure;

FIG. 14 is a side perspective view of two U-bolt spacers and a U-bolt, according to the U-bolt and U-bolt spacers shown in FIGS. 2, 8, and 13;

FIG. 15 is a top perspective view of a saddle-mount having a bolster, a frame of a truck, and four U-bolts in use with four U-bolt spacers, according to the embodiments shown in FIGS. 2, 8, and 13;

FIG. 16 is a fragmentary, reversed view of two U-bolts in use with two U-bolt spacers, according to the embodiments shown in FIGS. 2, 8, and 13;

FIG. 17 is a flow chart illustrating a method of using the U-bolt spacer, according to an embodiment of the present disclosure; and

FIG. 18 is a flow chart continuing from FIG. 17, and further illustrating the method of using the U-bolt spacer, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter

X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for case of description to describe one clement or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

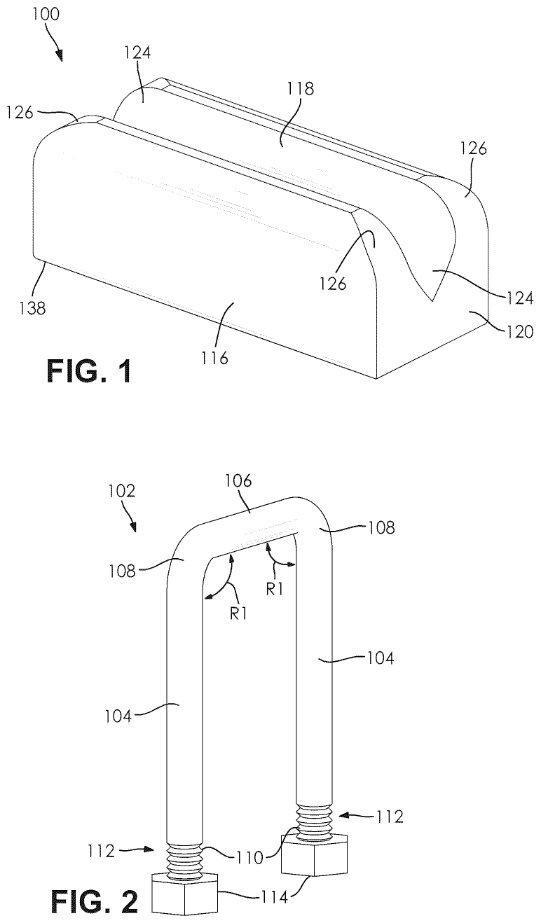

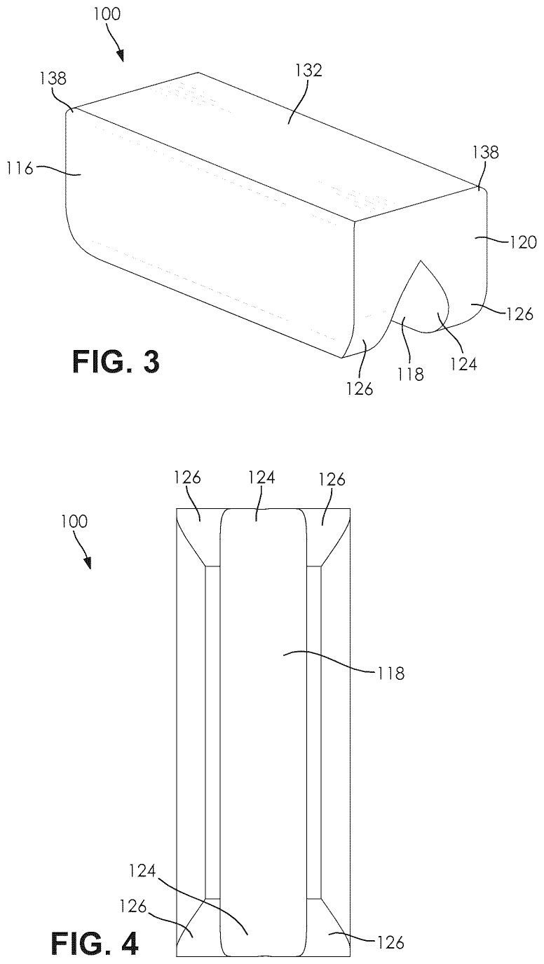

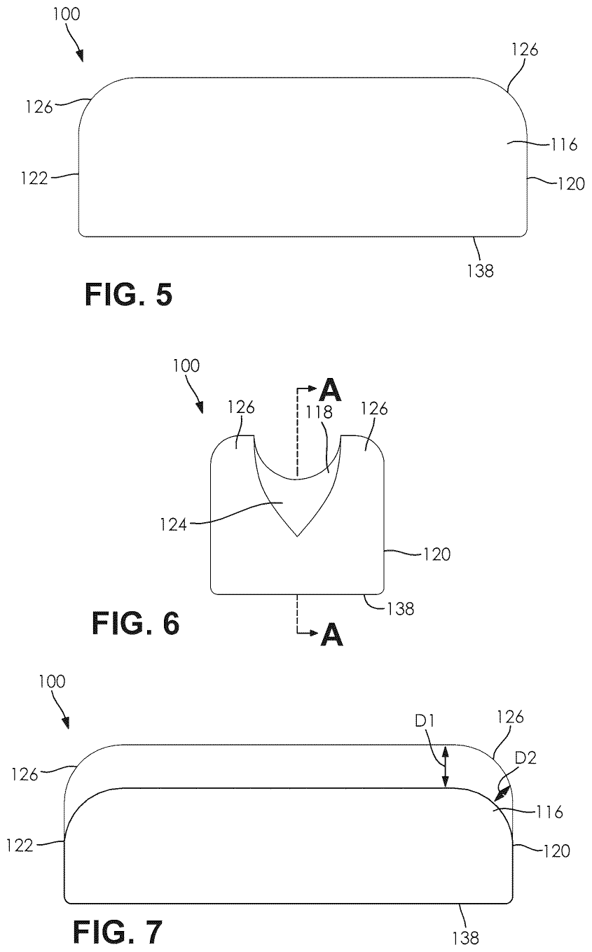

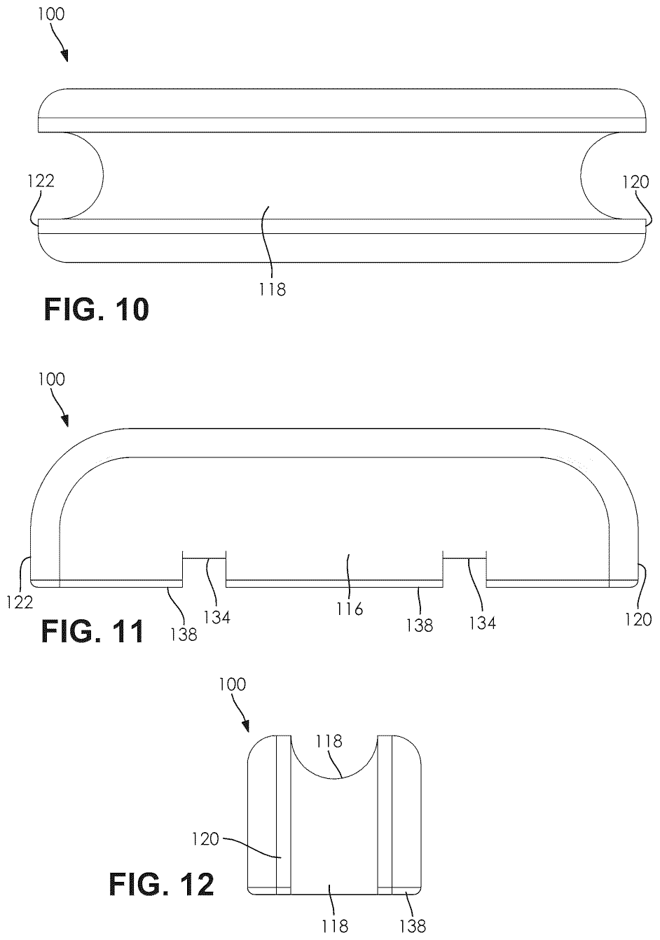

The present disclosure provides a U-bolt spacer 100 for use with a U-bolt 102, a method 200 of using the U-bolt spacer 100 with a U-bolt 102, and a system 300 for coupling saddle-mount 304 to a frame 302 of a truck, shown generally in FIGS. 1-18.

The U-bolt spacer 100 can be designed to cooperate with and complement a U-bolt 102. The U-bolt 102 can include substantially parallel arms 104, a connecting portion 106, and curved transitions 108 that connect the substantially parallel arms 104 to the connecting portion 106. The substantially parallel arms 104 can begin where the curved transitions 108 terminate, marking a transition point where the connecting portion 106 of the U-bolt 102 extends into the substantially parallel arms 104. Each of the curved transitions 108 can have a centerline radius or radius R1. As non-limiting examples, the radius R1 can be between 0.6703 and 1.181 inches and most particularly, 0.841 inches. One of ordinary skill in the art can select other suitable dimensions for the radius R1 within the scope of the present disclosure. Furthermore, it should be understood that the U-bolt 102 can have any type of curved transitions 108. As non-limiting examples, the curved transitions 108 can include round, square, and radiused or semi-round. One of ordinary skill in the art can select a suitable type of curved transitions 108 within the scope of the present disclosure.

Each of the substantially parallel arms 104 can include a threaded portion 110 disposed at a proximal end 112 of the U-bolt 102. Each threaded portion 110 can be designed to receive one or more nuts 114, enabling the U-bolt 102 to be secured to one or more objects. It should be understood that the substantially parallel arms 104 of the U-bolt 102 can deviate from true parallelism. As non-limiting examples, the deviation from true parallelism of the substantially parallel arms 104 can range from 1 degree to 5 degrees.

As shown in FIGS. 1-7, an embodiment of the U-bolt spacer 100 can include a body 116 and a channel 118. The body 116 can include a first end 120 and a second end 122. The channel 118 can be formed in the body 116 and can extend along the body 116 from the first end 120 to the second end 122. Each of the first end 120 and the second end 122 can have a complementary curvature 124 designed to cooperate with the curved transitions 108 of the U-bolt 102.

In certain embodiments, each of the first end 120 and the second end 122 can also include a chamfer 126. The chamfer 126 can serve multiple purposes. For example, the chamfer 126 can reduce the overall weight of the U-bolt spacer 100, thereby enhancing its efficiency without compromising strength or functionality. The chamfer 126 can eliminate sharp edges and/or 90-degree corners which can help reduce the likelihood of stress concentrations, which could otherwise lead to material fatigue over time.

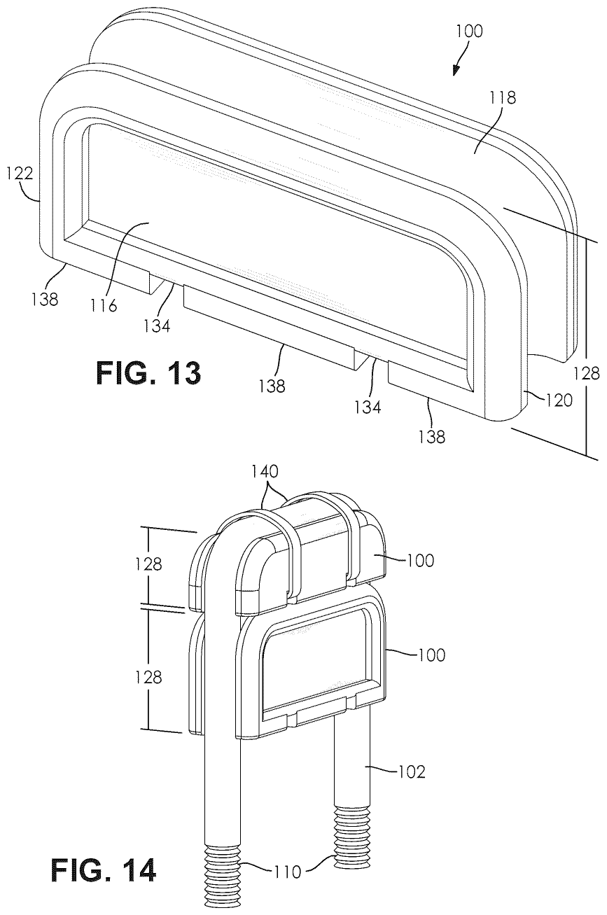

In some embodiments, and with reference to FIGS. 13 and 14, the U-bolt spacers 100 can be manufactured in various heights 128. The availability of various heights of the U-bolt spacer 100 can allow the U-bolt spacer 100 to accommodate a wider range of U-bolt 102 sizes. This adaptability in height can help ensure that the U-bolt spacer 100 can address varying structural geometries, providing a tailored solution that can maximize stability. It should be understood by one of ordinary skill in the art that the dimensions of the U-bolt spacer 100, such as a length or the height of the body 116, can be selected to cooperate with any size U-bolt 102 within the scope of the present disclosure.

In certain embodiments, two or more U-bolt spacers 100 can be stacked to further enhance versatility in applications requiring additional height. The ability to stack can allow the U-bolt spacer 100 to adapt to varying structural geometries or accommodate thicker components, such as mounting brackets or frame sections. By combining U-bolt spacers 100 of differing heights, users can fine-tune the overall height to accommodate clearance needs. The ability to mix and match U-bolt spacers 100 can help ensure that the U-bolt 102 can be adapted for both standard and non-standard installations.

The U-bolt spacer 100 can be constructed from a durable material, such as a cast metal, to maximize its effectiveness under load. The material can be selected to minimize compression under high-pressure conditions, allowing the U-bolt spacer 100 to maintain its shape and structural integrity over time. The strength and durableness of the material is important for supporting the pressure exerted when in use and for ensuring the U-bolt spacer 100 continues to provide consistent support to the U-bolt 102. Various cast metals, in particular, can offer excellent durability and resistance to deformation, making them well-suited for applications that require robust performance in heavy-duty environments. In should be understood that one of ordinary skill in the art can select a suitable material for the U-bolt spacer 100. As non-limiting examples, the material can include iron, steel, aluminum, magnesium, copper alloys, stainless steel, and titanium alloys.

In certain embodiments, the U-bolt spacer 100 can be manufactured using advanced 3D printing techniques with metal materials, such as stainless steel or titanium alloys. 3D printing can offer several advantages, including the ability to produce complex geometries with high precision, enabling the U-bolt spacer 100 to be tailored for optimal performance. Metal 3D printing methods, such as direct metal laser sintering (DMLS) or electron beam melting (EBM), provide suitable material properties, ensuring the U-bolt spacer 100 durable and resistant to deformation under load. Additionally, 3D printing allows for rapid prototyping and customization of dimensions to complement various U-bolts having various dimensions, making it possible to adapt design of the U-bolt spacer 100 for specific applications or load requirements without the need for extensive tooling. This manufacturing approach can further optimize the U-bolt spacer's 100 ability to distribute pressure evenly, minimize stress points, and maintain structural integrity in heavy-duty environments.

In certain embodiments, the U-bolt spacer 100 can include a protective coating, such as a corrosion-resistant coating, to improve longevity and performance in demanding environments. Protective coatings, such as galvanization, powder coating, or specialized corrosion-resistant paints, can shield the U-bolt spacer 100 from moisture, chemicals, oils, and other environmental factors that can lead to oxidation or degradation over time. By preventing corrosion, the protective coating can help maintain the U-bolt spacer's 100 structural integrity and ensure consistent support for the U-bolt 102. This can be particularly important in applications involving exposure to harsh weather or road salts, where unprotected metal components can be more susceptible to corrosion and wear. Adding a protective coating can not only extend the lifespan of the U-bolt spacer 100 but can also reduce the maintenance requirements and can help ensure reliable performance over prolonged periods of use.

With continued reference to FIGS. 1-7, the channel 118 can include a substantially U-shaped cross-section designed to receive and support the connecting portion 106 of the U-bolt 102. When the U-bolt spacer 100 is disposed adjacent to the U-bolt 102, the U-bolt spacer 100 can help militate bending stress by providing additional support to the connecting portion 106, thereby reducing deformation and preventing excessive bending of the U-bolt 102 during use. The U-bolt spacer 100 can help maintain the position of the U-bolt 102 after installation, ensuring that it remains securely in place and minimizes any movement that could lead to loosening or misalignment during use. The U-bolt spacer 100 can assist in distributing pressure on the truck frame more evenly, militating against stress concentrations at particular points in coupling a saddle-mount 304 to a frame 302, for example. By evenly distributing the pressure, the U-bolt spacer 100 can minimize wear and prevent damage of the frame 302 of the truck and the saddle-mount 304. It should be understood that one of ordinary skill in the art can select a suitable cross-section for the channel 118 to cooperate and conform with a particular U-bolt 102 configuration. As non-limiting examples, the channel 118 can have a V-shaped cross-section, a square-shaped cross-section, or a circular-shaped cross-section.

In certain embodiments, and with reference to FIG. 7, the channel 118 can include a first depth D1 and a second depth D2, where the first depth D1 can be greater than the second depth D2. The transition in depth can allow for a gradual curvature or taper. The channel 118 can taper from the first depth D1 to the second depth D2. The channel 118 can taper from the first depth D1 to the second depth D2 at the first end 120 thereby forming the complementary curvature 124 at the first end 120. In a similar fashion, the channel 118 can taper from the first depth to the second depth at the second end 122, thereby forming the complementary curvature 124 at the second end 122. Advantageously, the transition in depth can allow the complementary curvature 124 at the first end 120 and the second end 122 to help secure the U-bolt 102 in place.

The complementary curvature 124 at each of the first end 120 and second end 122 can help secure the U-bolt 102 in place. The complementary curvatures 124 can conform closely to the shape of the U-bolt 102, creating a snug fit that can reduce lateral and longitudinal movement during use. By aligning with the curved transitions 108 of the U-bolt 102, the complementary curvature 124 at each of the first end 120 and the second end 122 can help to evenly distribute load forces, minimizing stress concentrations that can lead to deformation or misalignment. Additionally, the snug fit provided by the complementary curvature 124 at each the first end 120 and the second end 122 can help militate the U-bolt 102 from shifting under dynamic loads, such as vibrations or sudden impacts from transportation on a highway. One of ordinary skill in the art can select suitable dimensions for each of the first depth D1 and the second depth D2.

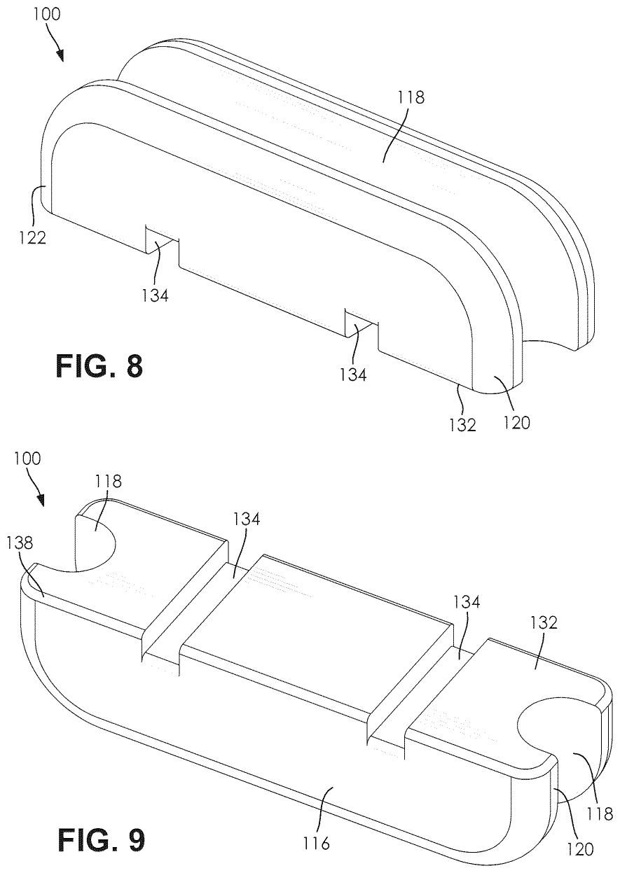

With reference to FIGS. 8-16, another embodiment of the U-bolt spacer 100 can include where the channel 118 extends from the body 116 along the first end 120 and the second end 122, creating a channel 118 having a substantially uniform depth that can extend along a length of the body 116 and a height of each the first end 120 and second end 122. The channel 118 can be designed to receive the connecting portion 106, each of the curved transitions 108 and the substantially parallel arms 104 of the U-bolt 102. The uniform depth can help ensure that the channel 118 closely conforms to the geometry of the U-bolt 102, securely accommodating the curved transitions 108 at the first end 120 and second end 122 while providing stable support for the substantially parallel arms 104. By capturing both the curved transitions 108 and substantially parallel arms 104 of the U-bolt 102, the channel 118 can minimize movement and enhance alignment of the U-bolt, ensuring a secure and stable connection during installation and under operational loads. Advantageously, this channel 118 can secure the U-bolt spacer 100 in place and prevent the U-bolt spacer 100 from being dislodged during use. The channel 118 can also facilitate an even distribution of forces across the U-bolt spacer 100, reducing stress concentrations and improving the durability of the overall assembly.

In certain embodiments, and with reference to FIGS. 8-13, each of the first end 120 and the second end 122 of the body 116 of the U-bolt 102 can be rounded. The rounding of the first end 120 and the second end 122 of the U-bolt spacer 100 can provide several functional and structural advantages. The rounded geometry can help minimize the presence of sharp edges or 90-degree corners that could potentially act as stress concentrators, thereby minimizing fatigue while under load. Additionally, the rounding of the first end 120 and second end 122 can enhance the U-bolt spacer's 100 compatibility with other components by preventing interference with surrounding structures.

With reference to FIG. 14, this channel 118 design can allow the U-bolt spacer 100 to be used in conjunction with one more additional U-bolt spacers 100 and act to match empty space or a gap left by an over-or improperly sized U-bolt. This channel 118 can enable multiple U-bolt spacers 100 to stack or align along the U-bolt 102, creating a modular system that can accommodate varying use cases. Additionally, the ability to use multiple U-bolt spacers 100 in tandem can provide flexibility for applications with unique demands.

U-bolt spacers 100 of different heights and dimensions can be mixed and matched to fill empty space or a gap left by an over-or improperly sized U-bolt 102. Users can combine U-bolt spacers 100 of varying heights to achieve alignment or spacing tailored to specific requirements. For example, a taller U-bolt spacer can be paired with a shorter U-bolt spacer, or multiple shorter U-bolt spacers 100 can be stacked to provide incremental adjustments.

In certain embodiments, and with reference to FIGS. 8-13, the U-bolt spacer 100 can further include a bottom surface 132 having one or more grooves 134. The one or more grooves 134 can be designed such that they can extend substantially perpendicular to a longitudinal axis of the bottom surface 132. The one or more grooves 134 can form a passageway when the bottom surface 132 of the U-bolt spacer 100 is disposed on, abutting, or contacting the frame 302 of the truck. The one or more grooves 134 can each include a square-shaped cross-section. It should be understood that one of ordinary skill in the art can select a suitable cross-section for the one or more grooves 134 within the scope of the present disclosure.

A cord 140, such as wire, rope, a zip tie, or cable tie, can be received through the passageway of the one or more grooves 134 and used to secure and/or tether the U-bolt spacer 100 to the U-bolt 102. Once a predetermined U-bolt spacer height 128 is selected, the cord 140 can be tightened to hold the U-bolt spacer 100 securely in place on the U-bolt 102, preventing unintentional movement or displacement. During coupling or decoupling of the U-bolt spacer 100 and U-bolt 102 to the saddle-mount 304, the cord 140 can prevent the U-bolt spacer from becoming dislodged or misplaced, streamlining the coupling and decoupling process and can reduce the risk of losing components.

In certain embodiments, and with reference to FIGS. 1-13, the bottom surface 132 of the U-bolt spacer 100 can further include a rounded edge 138. The rounded edge 138 can serve to reduce stress concentrations that can occur at sharp corners or 90-degree corners. By distributing forces more evenly, the rounded edge can minimize the likelihood of cracking or material fatigue while under load. This design not only can improve the structural integrity and durability of the U-bolt spacer 100 but can also contribute to its ability to perform reliably in demanding applications where dynamic loads and vibrations are present.

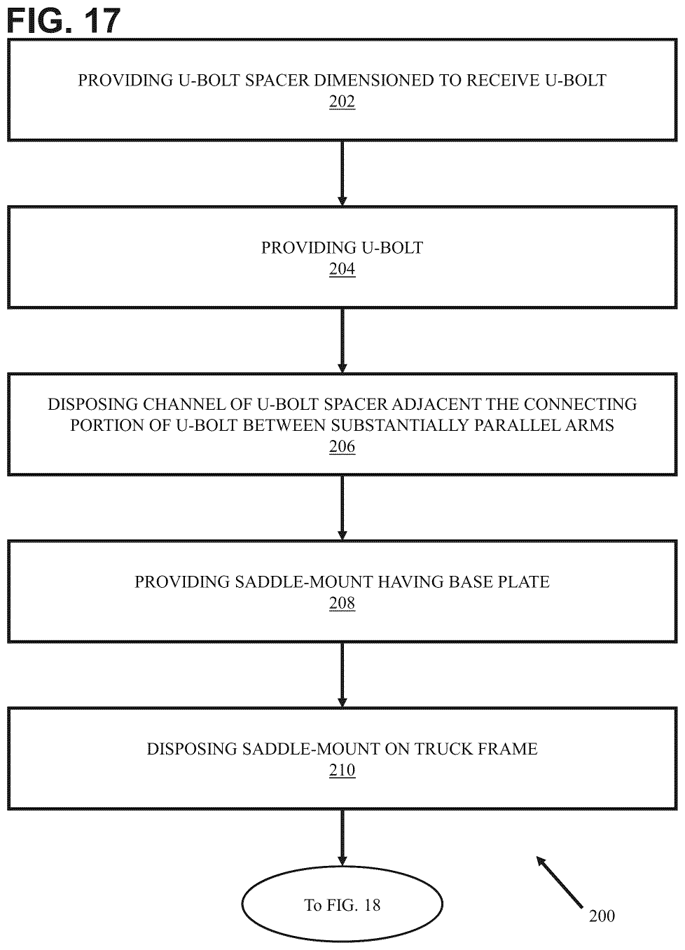

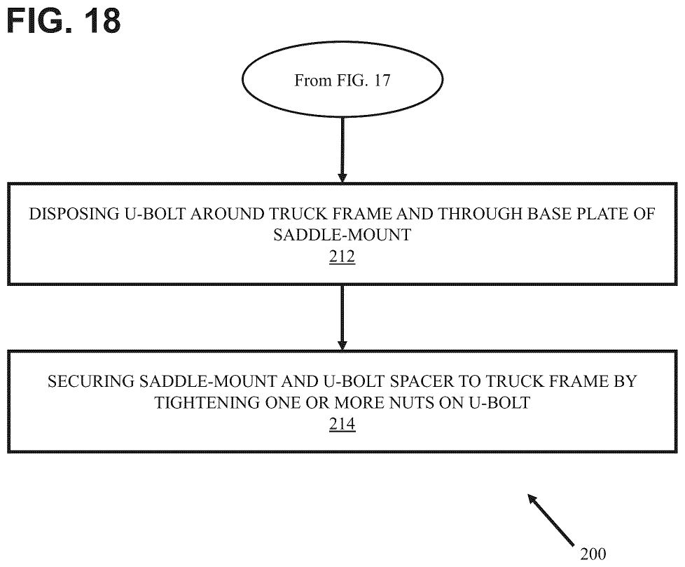

With refence to FIGS. 17-18, the present disclosure also contemplates a method 200 of using a U-bolt spacer 100 with a U-bolt 102. The U-bolt 102 can include substantially parallel arms 104, a connecting portion 106, and curved transitions 108 that connect the substantially parallel arms 104 to the connecting portion 106. The substantially parallel arms 104 can begin where the curved transitions 108 terminate, marking a transition point where the connecting portion 106 of the U-bolt 102 extends into the substantially parallel arms 104.

In a step 202, the U-bolt spacer 100, as described herein above, can be provided. Next, in a step 204, the U-bolt 102, can be provided. Then, the channel 118 of the U-bolt spacer 100 can be disposed adjacent to the connecting portion 106 of the U-bolt 102 between the substantially parallel arms 104. In a step 206, a saddle-mount 304 having a base plate 306 can be provided. The saddle-mount 304 can then be disposed on the frame 302 of the truck in a step 208. In a step 210, the U-bolt 102 can be disposed around the frame 302 of the truck and through the base plate 306 of the saddle-mount 304. The saddle-mount 304 and the U-bolt spacer 100 can be secured to the frame 302 of the truck by tightening one or more nuts 114 on the threaded portion 110 of the U-bolt 102.

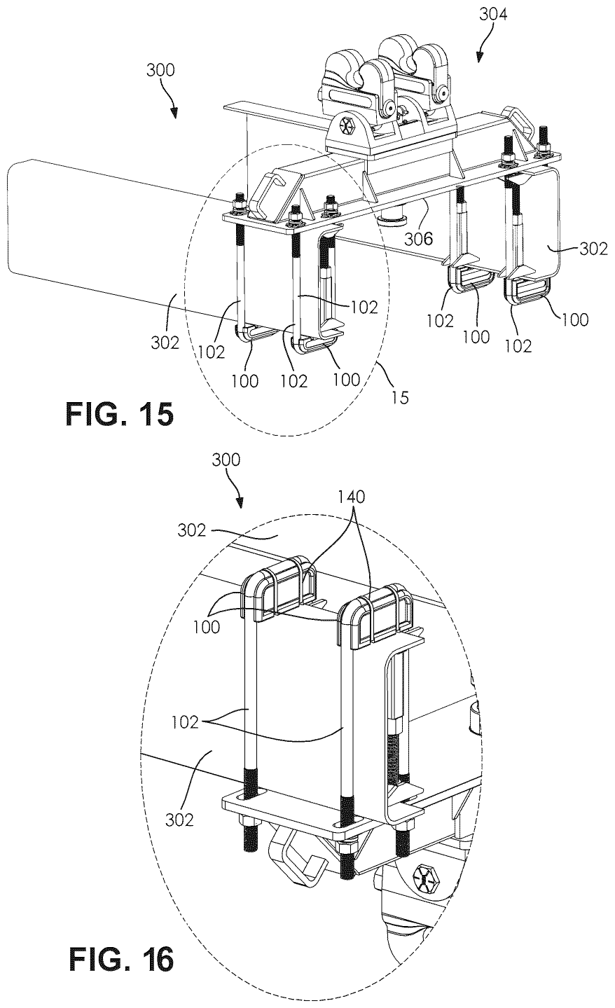

With reference to FIG. 15-16, the present disclosure further contemplates a system 300 for coupling a saddle-mount 304 to a frame 302 of a truck with a U-bolt spacer 100 and a U-bolt 102. The U-bolt 102 can include substantially parallel arms 104, a connecting portion 106, and curved transitions 108 that connect the substantially parallel arms 104 to the connecting portion 106. The substantially parallel arms 104 can begin where the curved transitions 108 terminate, marking a transition point where the connecting portion 106 of the U-bolt 102 extends into the substantially parallel arms 104. The system 300 can include one or more U-bolt spacers 100, one or more U-bolts 102, and one or more nuts 114. The one or more U-bolt spacers 100 can include U-bolt spacers of varying heights and length to accommodate U-bolts 102 of diverse dimensions.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A U-bolt spacer for use with a U-bolt, the U-bolt having substantially parallel arms, a connecting portion, and curved transitions between the connecting portion and the substantially parallel arms, the U-bolt spacer comprising:
a body including a first end and a second end; and
a channel formed in the body, the channel extending along the body from the first end to the second end, the channel at each of the first end and the second end having a complementary curvature configured to cooperate with the curved transitions of the U-bolt, thereby allowing the channel to receive the connecting portion and the curved transitions of the U-bolt.

2. The U-bolt spacer of claim 1, wherein each of the first end and the second end include a chamfer.

3. The U-bolt spacer of claim 1, wherein the channel includes a substantially U-shaped cross-section.

4. The U-bolt spacer of claim 1, wherein the channel includes a first depth and a second depth, and the first depth is greater than the second depth.

5. The U-bolt spacer of claim 4, wherein the channel tapers from the first depth to the second depth.

6. The U-bolt spacer of claim 4, wherein the channel tapers from the first depth to the second depth at the first end thereby forming the complementary curvature at the first end.

7. The U-bolt spacer of claim 4, wherein the channel tapers from the first depth to the second depth at the second end thereby forming the complementary curvature at the second end.

8. The U-bolt spacer of claim 4, wherein the channel tapers from the first depth to the second depth at both the first end and the second end thereby forming the complementary curvature at both the first end and the second end.

9. The U-bolt spacer of claim 1, wherein the channel extends from the body along the first end and the second end.

10. The U-bolt spacer of claim 1, wherein the channel maintains a substantially uniform depth and extends from the body along the first end and the second end.

11. The U-bolt spacer of claim 10, wherein the channel is configured to receive the connecting portion, the curved transitions, and the substantially parallel arms of the U-bolt.

12. The U-bolt spacer of claim 1, wherein the body further includes a bottom surface having a groove.

13. The U-bolt spacer of claim 12, wherein the groove extends perpendicular to a longitudinal axis of the bottom surface.

14. The U-bolt spacer of claim 12, wherein the groove is configured to receive a cable tie to secure the U-bolt spacer to the U-bolt.

15. The U-bolt spacer of claim 12, wherein the groove is configured to cooperate with a frame of a truck to form a passageway when the bottom surface contacts the frame of the truck.

16. The U-bolt spacer of claim 12, wherein the bottom surface includes a plurality of grooves.

17. The U-bolt spacer of claim 16, wherein each groove of the plurality of grooves includes a substantially square shaped cross-section.

18. A method of using a U-bolt spacer with a U-bolt, the U-bolt having substantially parallel arms, a connecting portion, and curved transitions between the connecting portion and the substantially parallel arms, the method comprising:
providing the U-bolt spacer dimensioned to receive the U-bolt, the U-bolt spacer including:
a body including a first end and a second end; and
a channel formed in the body, the channel extending along the body from the first end to the second end, the channel at each of the first end and the second end having a complementary curvature configured to cooperate with the curved transitions of the U-bolt, thereby allowing the channel to receive the connecting portion and the curved transitions of the U-bolt;
providing the U-bolt; and
disposing the channel of the U-bolt spacer on the connecting portion of the U-bolt between the substantially parallel arms.

19. The method of using the U-bolt spacer with the U-bolt of claim 18, the U-bolt having substantially parallel arms, a connecting portion, and curved transitions between the connecting portion and the substantially parallel arms, the method comprising:
providing a saddle-mount having a base plate;
disposing a saddle-mount on a frame of a truck;
disposing the U-bolt around the frame of the truck and through the base plate of the saddle-mount; and
securing the saddle-mount and the U-bolt spacer to the frame of the truck by tightening one or more nuts on the U-bolt.

20. A system for coupling a saddle-mount to a frame of a truck with a U-bolt spacer and a U-bolt, the U-bolt having substantially parallel arms, a connecting portion, and curved transitions between the connecting portion and the substantially parallel arms, the system comprising:
the U-bolt spacer, the U-bolt spacer including:
a body including a first end and a second end; and
a channel formed in the body, the channel extending along the body from the first end to the second end, the channel at each of the first end and the second end having a complementary curvature configured to cooperate with the curved transitions of the U-bolt, thereby allowing the channel to receive the connecting portion, the curved transitions and the substantially parallel arms of the U-bolt;
the U-bolt; and
a plurality of nuts.
